(19) United States
(12) Patent Application Publication
(10) Pub. No.: US 2011/0255097 A1
(43) Pub. Date: Oct. 20, 2011

(54) METHOD AND SYSTEM FOR EVALUATING A HEIGHT OF STRUCTURES

(76) Inventors: Gilad GOLAN, Raanana (IL); Yacov Malinovitch, Kiryat Tivon (IL)

(21) Appl. No.: 13/047,814

(22) Filed: Mar. 15, 2011

Related U.S. Application Data
(60) Provisional application No. 61/315,093, filed on Mar. 18, 2010.

(51) Int. Cl. G01B 11/02

(52) U.S. Cl. 356/496

(57) ABSTRACT

A system and method for measuring a height difference between an extremum portion of a microscopic structure and a background element, the method includes detecting, by a sensor, first and second interference patterns by a sensor; wherein the first and second interference patterns are generated by illuminating an area of a sample by a first light beam and directing towards the sensor a first reference light beam of a first wavelength (w1) and light of the first wavelength (w1) that is either reflected from the area or passes through the area; wherein the second interference patterns are generated by illuminating the area of the sample by a second light beam and directing towards the sensor a second reference light beam of a second wavelength (w2) and light of the second wavelength (w2) that is either reflected from the area or passes through the area; wherein w1 differs from w2; wherein H<ws/2, wherein ws=(w1×w2)/∥w1−w2∥; generating, in response to the first and second interference patterns, first and second wavelength phase information about the microscopic structure; detecting, in the first and second wavelength phase information, first and second wavelength extremum portion information; and calculating the height of the extremum portion of the microscopic structure based on the first and second wavelength extremum portion information.

### RELATED APPLICATIONS

This Application claims priority from U.S. provisional patent Ser. No. 61/315,093 filing date Mar. 18, 2010 which is incorporated herein by reference.

### BACKGROUND OF THE INVENTION

Electrical circuits and other samples may include multiple microscopic structures that should be measured for various purposes.

Digital holographic microscopes such as the DHM R1100™ of Lyncee Tec of Lausanne Switzerland use two laser sources that can be simultaneously or alternatively switched or continuously operate to illuminate a sample. Light from the sample and references beams is processed to provide phase information and amplitude information. The structure of the DHM R1100 is described in “Digital holographic reflectometry”. Optics Express Vol. 18, No. 4, 15 Feb. 2010, which is incorporated herein by reference.

There is a growing need to provide fast and accurate means for measuring the height of microscopic structures.

### SUMMARY

According to an embodiment of the invention a method is provided, the method is for measuring a height difference (H) between a extremum portion of a microscopic structure and a background element, the method may include: detecting, by a sensor, first and second interference patterns by a sensor; wherein the first interference patterns are generated by illuminating an area of a sample by a first light beam and directing towards the sensor a first reference light beam of a first wavelength (w1) and light of the first wavelength (w1) that is either reflected from the area or passes through the area; wherein the second interference patterns are generated by illuminating the area of the sample by a second light beam and directing towards the sensor a second reference light beam of a second wavelength (w2) and light of the second wavelength (w2) that is either reflected from the area or passes through the area; wherein the second wavelength (w2) differs from the first wavelength (w1); wherein the area comprises the extremum portion of the microscopic structure; wherein the height different H is smaller than half of a synthetic wavelength (ws) that equals a ratio between (w1×w2) and a difference between w1 and w2; wherein H exceeds w1 and w2; generating, in response to the first and second interference patterns, first and second wavelength phase information about the microscopic structure; detecting, in the first and second wavelength phase information, first and second wavelength extremum portion information; and calculating the height of the extremum portion of the microscopic structure based on the first and second wavelength extremum portion information.

According to an embodiment of the invention a system is provided for measuring a height difference (H) between a extremum portion of a microscopic structure and a background element, the system may include a sensor arranged to detect, first and second interference patterns by a sensor; wherein the first interference patterns are generated by illuminating an area of a sample by a first light beam and directing towards the sensor a first reference light beam of a first wavelength (w1) and light of the first wavelength (w1) that is either reflected from the area or passes through the area; wherein the second interference patterns are generated by illuminating the area of the sample by a second light beam and directing towards the sensor a second reference light beam of a second wavelength (w2) and light of the second wavelength (w2) that is either reflected from the area or passes through the area; wherein the second wavelength (w2) differs from the first wavelength (w1); wherein the area comprises the extremum portion of the microscopic structure; wherein the height different H is smaller than half of a synthetic wavelength (ws) that equals a ratio between (w1×w2) and a difference between w1 and w2; wherein H exceeds w1 and w2; and a processor, arranged to: generate, in response to the first and second interference patterns, first and second wavelength phase information about the microscopic structure; detect, in the first and second wavelength phase information, first and second wavelength extremum portion information; and calculate the height of the extremum portion of the microscopic structure based on the first and second wavelength extremum portion information.

The first light beam may impinge on the area at a first angle of incidence; wherein the second light beam may impinge on the area at a second angle of incidence that differs from the first angle of incidence.

The microscopic structure may further include an intermediate portion positioned between the extremum portion and the background element; wherein light reflected from the intermediate portion, as a result from the illumination of the area by the first and second light beams, is outside a field of view of the sensor.

The first and second wavelength phase information about the microscopic structure comprise first and second wavelength intermediate information may include pixels of values representative of an insignificant reflectance of light from the intermediate portion.

The method may include detecting, in the first and second wavelength phase information, the first and second wavelength extremum portion information based on an expected location of the extremum portion.

The method may include obtaining a two dimensional image of the area and detecting, in the first and second wavelength phase information, the first and second wavelength extremum portion information based on a location of the extremum portion in the two dimensional image.

The method may include filtering first and second wavelength phase information pixels based on an expected height of the extremum portion.

The method may include calculating the height of the extremum portion of the microscopic structure by averaging pixels of the first and second wavelength extremum portion information.

The method may include calculating the height of the extremum portion of the microscopic structure by applying a spatial filter on pixels of the first and second wavelength extremum portion information.

The method may include calculating the height of the extremum portion of the microscopic structure based on at least fifty pixels of the first and second wavelength extremum portion information.

The method may include detecting pixels of the first and second wavelength intermediate information based on values of pixels representative of an insignificant reflectance of light from the intermediate portion; and detecting a location of pixels of the first and second wavelength extremum information based on locations of the pixels of the first and second wavelength intermediate information.

The method may include introducing a relative movement between the sensor and the sample and detecting first and second interference patterns from multiple areas that differ from each other; and repeating the generating, detecting and calculating from multiple microscopic structures located in the different areas.

The method may include detecting, by a group of sensors that comprises the sensor and at least zero additional sensors, multiple additional interference patterns; wherein the at least one additional interference patterns are generated by illuminating the area of the sample by multiple additional light beams and directing towards the sensor multiple additional wavelengths reference light beam of multiple additional wavelengths and light of the multiple additional wavelengths that is either reflected from the area or passes through the area; wherein the multiple additional wavelengths differs from the first and second wavelengths; generating, in response to first, second and multiple additional interference patterns, first, second and multiple additional wavelength phase information about the microscopic structure; detecting, in the first, second and multiple additional wavelength phase information, first, second and multiple additional wavelength extremum portion information; and calculating the height of the extremum portion of the microscopic structure based on the first, second and multiple additional extremum portion information.

The processor may be arranged to detect, in the first and second wavelength phase information, the first and second wavelength extremum portion information based on an expected location of the extremum portion.

The processor may be arranged to receive a two dimensional image of the area and to detect, in the first and second wavelength phase information, the first and second wavelength extremum portion information based on a location of the extremum portion in the two dimensional image.

The processor may be arranged to filter first and second wavelength phase information pixels based on an expected height of the extremum portion.

The processor may be arranged to calculating the height of the extremum portion of the microscopic structure by averaging pixels of the first and second wavelength extremum portion information.

The processor may be arranged to calculate the height of the extremum portion of the microscopic structure by applying a spatial filter on pixels of the first and second wavelength extremum portion information.

The processor may be arranged to calculate the height of the extremum portion of the microscopic structure based on at least fifty pixels of the first and second wavelength extremum portion information.

The processor may be arranged to detect pixels of the first and second wavelength intermediate information based on values of pixels representative of an insignificant reflectance of light from the intermediate portion; and to detect a location of pixels of the first and second wavelength extremum information based on locations of the pixels of the first and second wavelength intermediate information.

The system may include a stage arranged to introduce a relative movement between the sensor and the sample; wherein the sensor may be arranged to detect first and second interference patterns from multiple areas that differ from each other; wherein the processor may be arranged to repeat to generate first and second wavelength phase information about the microscopic structure; to detect first and second wavelength extremum portion information; and to calculate the height of extremum portions of microscopic structures located in the different areas.

The sensor (or at least one additional sensor) may be arranged to detect at least one additional interference patterns; wherein the at least one additional interference patterns are generated by illuminating the area of the sample by at least one additional light beam and combine the reflected or transmitted light with at least one additional reference light beam of at least one additional wavelength that differs from the first and second wavelengths; wherein the processor may be arranged to: generate, in response to first, second and at least one additional interference patterns, first, second and at least one additional wavelength phase information about the microscopic structure; detect, in the first, second and at least one additional wavelength phase information, first, second and at least one additional wavelength extremum portion information; and calculate the height of the extremum portion of the microscopic structure based on the first, second and at least one additional extremum portion information.

The system may include a group of sensors that comprises the sensor and at least zero additional sensors, the group of sensors arranged to detect multiple additional interference patterns; wherein the at least one additional interference patterns are generated by illuminating the area of the sample by multiple additional light beams and combine the reflected or transmitted light with multiple additional reference light beams of multiple additional wavelengths that differs from the first and second wavelengths; wherein the processor may be arranged to: generate, in response to first, second and multiple additional interference patterns, first, second and multiple additional wavelength phase information about the microscopic structure; detect, in the first, second and multiple additional wavelength phase information, first, second and multiple additional wavelength extremum portion information; and calculate the height of the extremum portion of the microscopic structure based on the first, second and multiple additional extremum portion information.

According to an embodiment of the invention a computer program product is provided that includes a non-transitory computer readable medium that stores instructions for measuring a height difference (H) between a extremum portion of a microscopic structure and a background element, the instruction comprise instructions for: detecting, by a sensor, first and second interference patterns by a sensor; wherein the first interference patterns are generated by illuminating an area of a sample by a first light beam and directing towards the sensor a first reference light beam of a first wavelength (w1) and light of the first wavelength (w1) that is either reflected from the area or passes through the area; wherein the second interference patterns are generated by illuminating the area of the sample by a second light beam and directing towards the sensor a second reference light beam of a second wavelength (w2) and light of the second wavelength (w2) that is either reflected from the area or passes through the area; wherein the second wavelength (w2) differs from the first wavelength (w1); wherein the area comprises the extremum portion of the microscopic structure; wherein the height different H is smaller than half of a synthetic wavelength (ws) that equals a ratio between (w1×x w2) and a difference between w1 and w2; wherein H exceeds w1 and w2; generating, in response to the first and second interference patterns, first and second wavelength phase information about the microscopic structure; detecting, in the first and second wavelength phase information, first and second wavelength extremum portion information; and calculating the height of the extremum portion of the microscopic structure based on the first and second wavelength extremum portion information.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a system according to an embodiment of the invention;

FIG. 2 illustrates a system according to an embodiment of the invention;

FIG. 3 illustrates a system according to an embodiment of the invention;

FIG. 4 illustrates a system according to an embodiment of the invention;

FIG. 5 illustrates a cross sectional view of a bump, light beams, reference light beams and reflected light beams and wavelength relationship according to an embodiment of the invention;

FIG. 6 illustrates a first wavelength phase image and a second wavelength phase image of a bump according to an embodiment of the invention;

FIG. 7 illustrates a method according to an embodiment of the invention;

FIG. 8 illustrates a method according to an embodiment of the invention; and

FIG. 9 illustrates a system according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although the drawings of some of the text below illustrates a system and method that sense reflected light from an area it is noted that the method and system can be applied mutatis mutandis to sensors that sense light that passes through the area of the sample.

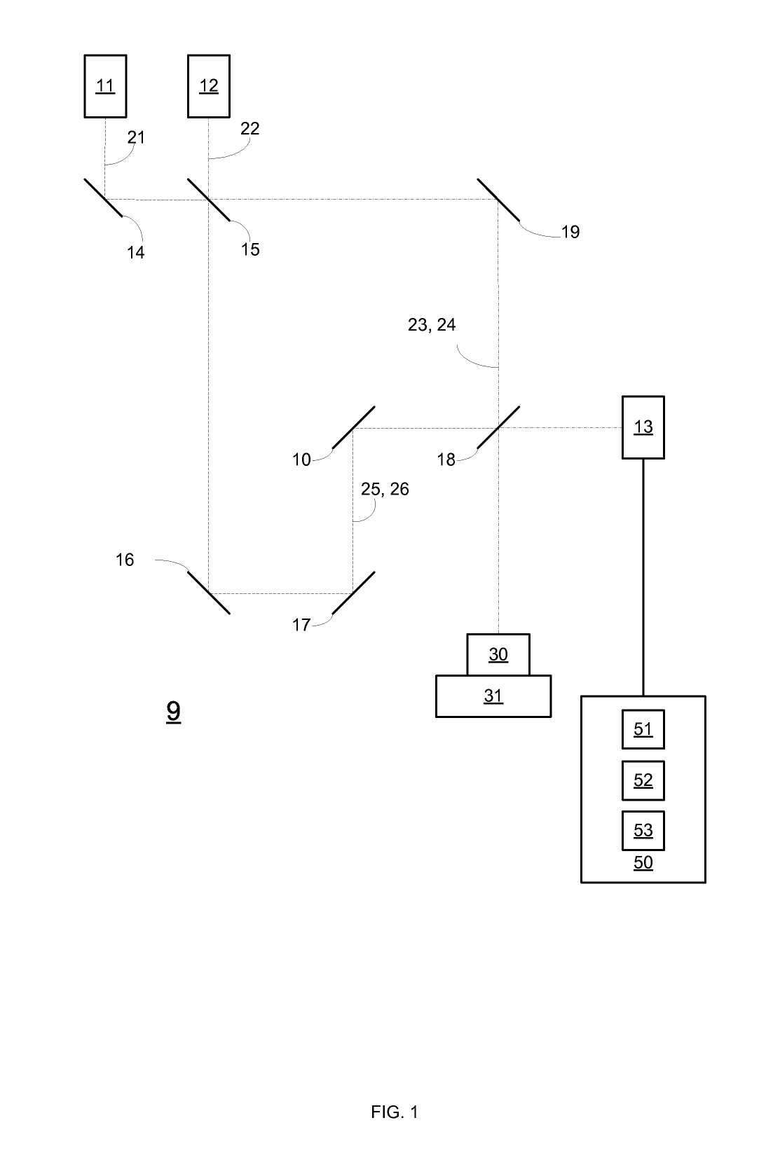

FIG. 1 illustrates a system 9 according to an embodiment of the invention.

System 9 is arranged to measure a height difference (H) between a extremum portion of a microscopic structure and a background element. The system 9 may perform multiple measurements of such height differences. It is noted that the following figures and explanations refer to an extremum portion that is above the background element but that the extremum portion can be located below the background element. Non-limiting examples of the former include a bump and a conductor while non-limiting examples of the latter include a void, a via and a trench.

The background element may be a surface of an electrical circuit or a layer on which the microscopic structure is formed. It is termed “background element” as the height of the extremum portion is measured in relation to it.

System 9 may include:

i. At least one sensor such as sensor 13,
ii. A first light source 11 and second light source 12,
iii. Optical elements such as mirrors 14, 16, 17, 19 and 10, beam splitters 15 and 18 and lenses (not shown but may include objective lenses, filters condensing lenses, and the like),
iv. Processor 50.

The term beam splitter refers to any optical element that can split a light beam or otherwise change the path of a light beam. A beam splitter can respond in different manners to light beams that enter the beam splitter from different locations, and additionally or alternatively to light beams of different wavelengths.

Each light source can be a laser or any other light source. It can generate a frequency comb that includes the first and second wavelengths and even one or more additional wavelengths. The frequency comb can be a spectrum that includes equidistant lines. These lines can be of the first wavelength, of the second wavelength or of at least one additional wavelength.

Each light source may create all the required wavelengths and that light of multiple wavelengths can illuminate the sample and also be used to generate reference light beams.

The first light source 11 can be a laser that emits light of a first wavelength. A light beam having a first wavelength is generated by the first light source 11, deflected by mirror 14, and be split by beam splitter 15. A portion (referred to as first light beam) 23 is reflected by mirror 19 and passes through beam splitter 18 to impinge on sample 30. Another portion (referred to as first reference light beam) 25 is reflected by mirrors 16, 17 and 10 and passes through beam splitter 18 to impinge on sensor 13.

The first light beam 23 may impinge on the area of the sample 30 at a first angle of incidence. The second light beam and the second may impinge on the area at a second angle of incidence that differs from the first angle of incidence.

The first light beam and the first reference light beam 25 are literally “combined” to generate first interference patterns on sensor 13. The first light beam is reflected from sample 30 towards beam splitter 18 and is combined with the first reference light beam and both are directed (by the beam splitter 18) towards sensor 13.

The second light source 12 can be a laser that emits light as a second wavelength. A light beam having a second wavelength is generated by the second light source 12 and is split by beam splitter 15. A portion (referred to as second light beam) 24 is reflected by mirror 19 and passes through beam splitter 18 to impinge on sample 30. Another portion (referred to as second reference light beam) 26 is reflected by mirrors 16, 17 and 10 and is transmitted through beam splitter 18 to impinge on sensor 13. The second light beam 23 and the second reference light beam 25 generate second interference patterns on sensor 13. The second light beam is reflected from sample 30 towards beam splitter 18 and is combined with the second reference light beam and both are directed (by the beam splitter 18) towards sensor 13.

Although FIG. 1 illustrates that the first and second reference light beam 25 and 26 pass a longer path than the first and second light beams 23 and 24 this is not necessarily so as they may pass through a shorter path or otherwise delayed in a different manner.

Sensor 13 can be an area sensor. It may include one or more sensing element arrays such as a single CCD or multiple CCD arrays.

Processor 50 is illustrated as including:

i. Generating module 51 that may be arranged to generate, in response to the first and second interference patterns, first and second wavelength phase information about the microscopic structure using specific algorithms.
ii. Detection module 52 that may be arranged to detect, in the first and second wavelength phase information, first and second wavelength extremum portion information.
iii. Calculation module 53, that may be arranged to calculate the height of the extremum portion of the microscopic structure based on the first and second wavelength extremum portion information.

Generating module 51 may generate, in response to the first and second interference patterns, first and second wavelength phase information about the microscopic structure by applying known digital holographic microscopy algorithms. These may be first and second wavelength phase and, additionally or alternatively amplitude images.

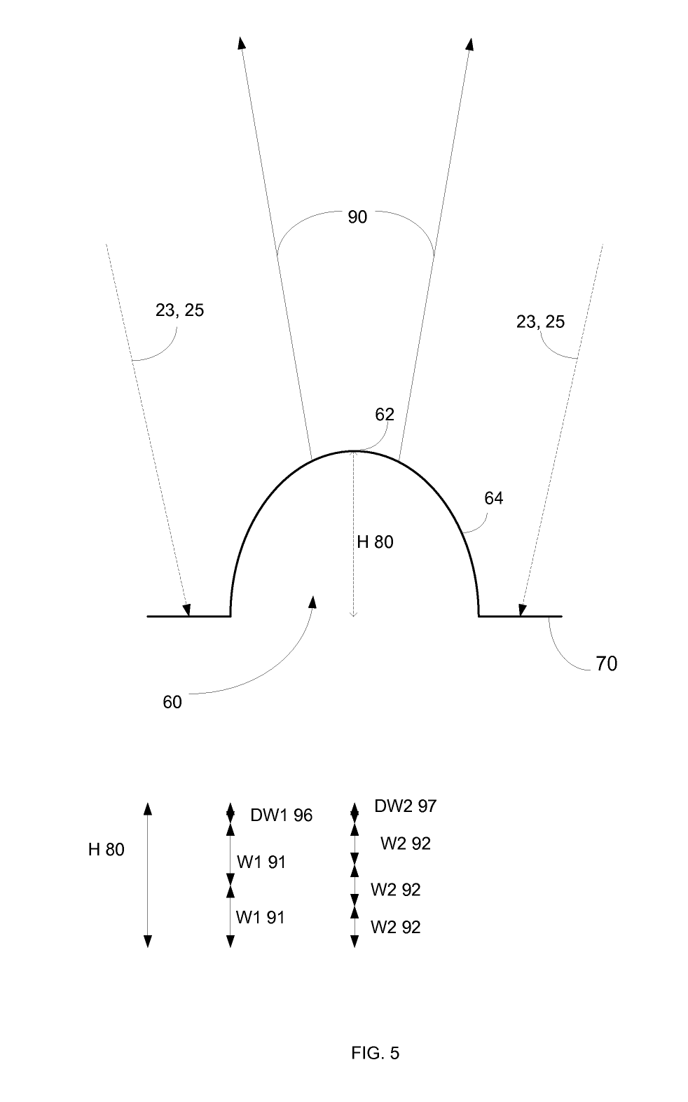

FIG. 5 illustrates a bump 60 that is placed on a background element 70. The bump 60 has a extremum portion 62 and an intermediate portion 64 that surrounds it. Due to the circular structure of the bump 60 and the normal illumination and collection of system 9, interference patterns reflected from the intermediate portion 62 propagate outside the field of view of the sensor 13, while interference patterns 90 reflected from the extremum portion 62 is within the field of view of sensor 13. Accordingly, the intermediate portion 64 is viewed as black (no reflected light or almost no reflected light).

Due to noises and optical imperfection of system 9, the image of the bump can be noisy and deformed.

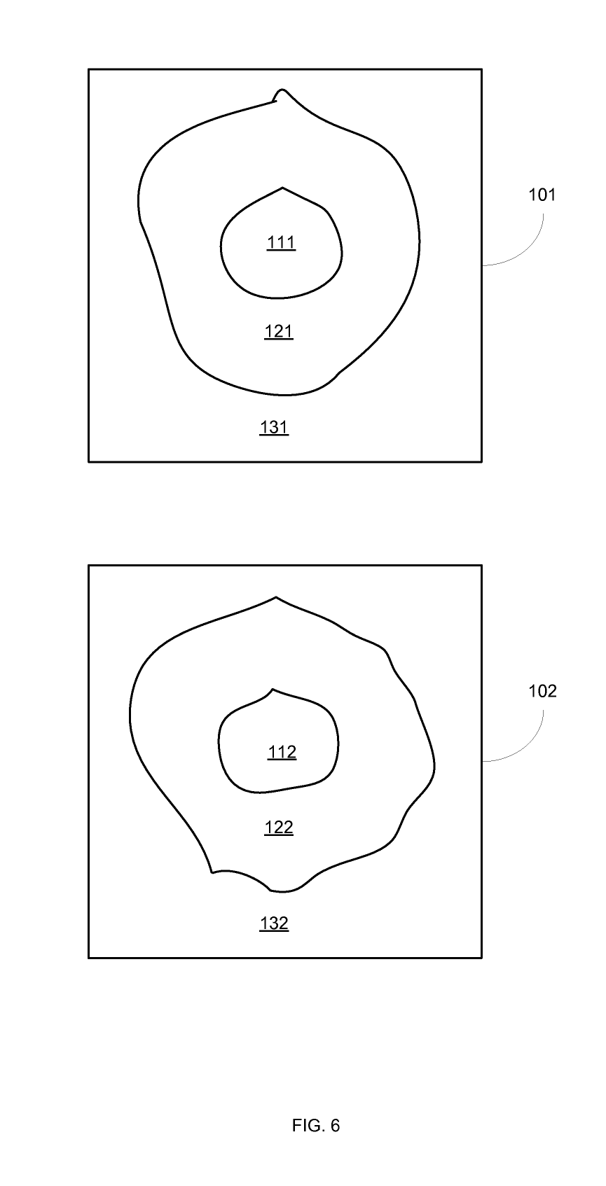

FIG. 6 illustrates the first wavelength phase image 101 and the second wavelength phase image 102 that are example of first and second wavelength phase information about the bump 60. The first wavelength phase image 101 includes a center that may represent the extremum portion 62 of the bump, intermediate portion pixels 121 that may be dark (or otherwise represent no reflection or low reflection) and background pixels 131. The first wavelength phase image 101 includes a height ambiguity—as H equals a multiple integer of w1 91 as well as a fraction (that may be zero) of w1 (DW1 98) and this multiple integer is not known.

The second wavelength phase image 102 includes a center that may represent the extremum portion 62 of the bump, intermediate portion pixels 122 that may be dark (or otherwise represent no reflection or low reflection) and background pixels 132. The second wavelength phase image 102 includes a height ambiguity—as H equals a multiple integer of w2 92 as well as a fraction (that may be zero) of w2 (DW2 97) and this multiple integer is not known. Actually, the first and second wavelength phase images 101 and 102 represent the fraction of w1 and w2.

The height ambiguity is resolved by using multiple second wavelength phase image pixels and multiple first wavelength phase image pixels.

Referring back to FIG. 1, the detection module 52, may be arranged to perform at least one of the following:

i. Detecting, in the first and second wavelength phase information, the first and second wavelength extremum portion information based on an expected location of the extremum portion wherein the expected location can be learnt from locations of other structural elements, can be driven from design information or any other manner.
ii. Detecting, in the first and second wavelength phase information, the first and second wavelength extremum portion information based on a location of the extremum portion in a two dimensional image that may be acquired by the same sensor (using non-holographic illumination) or using another sensor.
iii. Filtering first and second wavelength phase information pixels based on an expected height of the extremum portion.
iv. Detecting pixels that represent very low or no reflectance (for example—from the intermediate portion) wherein at least a predefined minimal number of such pixels can provide an indication about an intermediate portion of the microscopic structure that is not expected to reflect light towards the sensor, and defining pixels that are proximate to these pixels as belonging to the extremum portion.

The calculation module 53 may be arranged to perform at least one of the following:

i. Calculating the height of the extremum portion of the microscopic structure by averaging pixels of the first and second wavelength extremum portion information, the averaging can reduce errors.
ii. Calculating the height of the extremum portion of the microscopic structure by applying a spatial filter on pixels of the first and second wavelength extremum portion information.
iii. Calculating the height of the extremum portion of the microscopic structure based on a large number of pixels (for example—at least fifty pixels) of the first and second wavelength extremum portion information. Larger numbers of processed pixels can increase the accuracy of the measurement.

Sample 30 is located on a stage (that may include a chuck) 31. Stage 31 may introduce a movement between the sensor 13 and the object 30 in order to image multiple areas of the object 30 and multiple structural elements.

The stage 31 can move along a predefined scan pattern and either one or both of the light sources (21 and 22) or the sensor 13 can be activated during short periods (pulsate).

The sensor 13 may be arranged to detect first and second interference patterns from multiple areas of the sample 30 that differ from each other. The processor 50 may be arranged to repeat to generate first and second wavelength phase information about the microscopic structure; to detect first and second wavelength extremum portion information; and to calculate the height of extremum portions of microscopic structures located in the different areas.

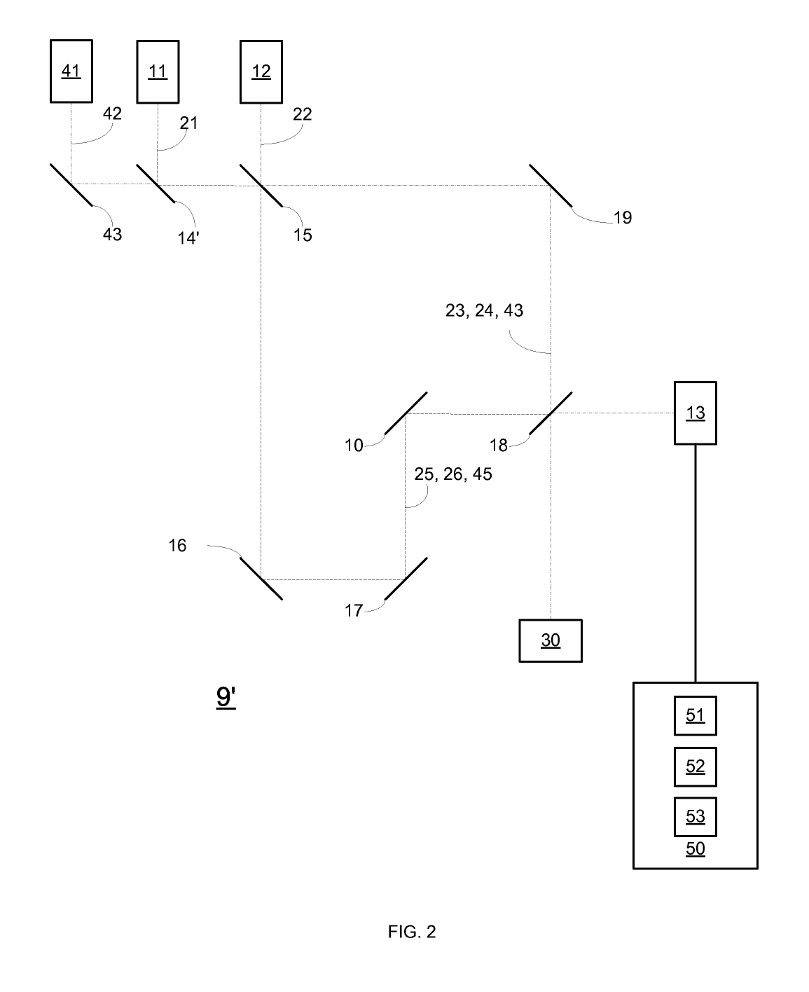

FIG. 2 illustrates a system 9′ according to an embodiment of the invention.

System 9′ of FIG. 2 differs from system 9 of FIG. 1 by including an additional light source 41, an additional mirror 43 and by replacing mirror 14 by beam splitter 14′.

The additional light source 41 can be a laser that emits light at an additional wavelength. A light beam having an additional wavelength is generated by the additional light source 41, deflected by mirror 43, passes through beam splitter 14′, and is split by beam splitter 15. A portion (referred to as additional light beam) 43 is reflected by mirror 19 and passes through beam splitter 18 to impinge on sample 30. Another portion (referred to as additional reference light beam) 45 is reflected by mirrors 16, 17 and 10 and is transmitted by beam splitter 18 to impinge on sensor 13. The additional light beam 43 and the additional reference light beam 45 generate interference patterns on sensor 13. The additional light beam is reflected from sample 30 towards beam splitter 18 and is combined with the additional reference light beam and both are directed (by the beam splitter 18) towards sensor 13.

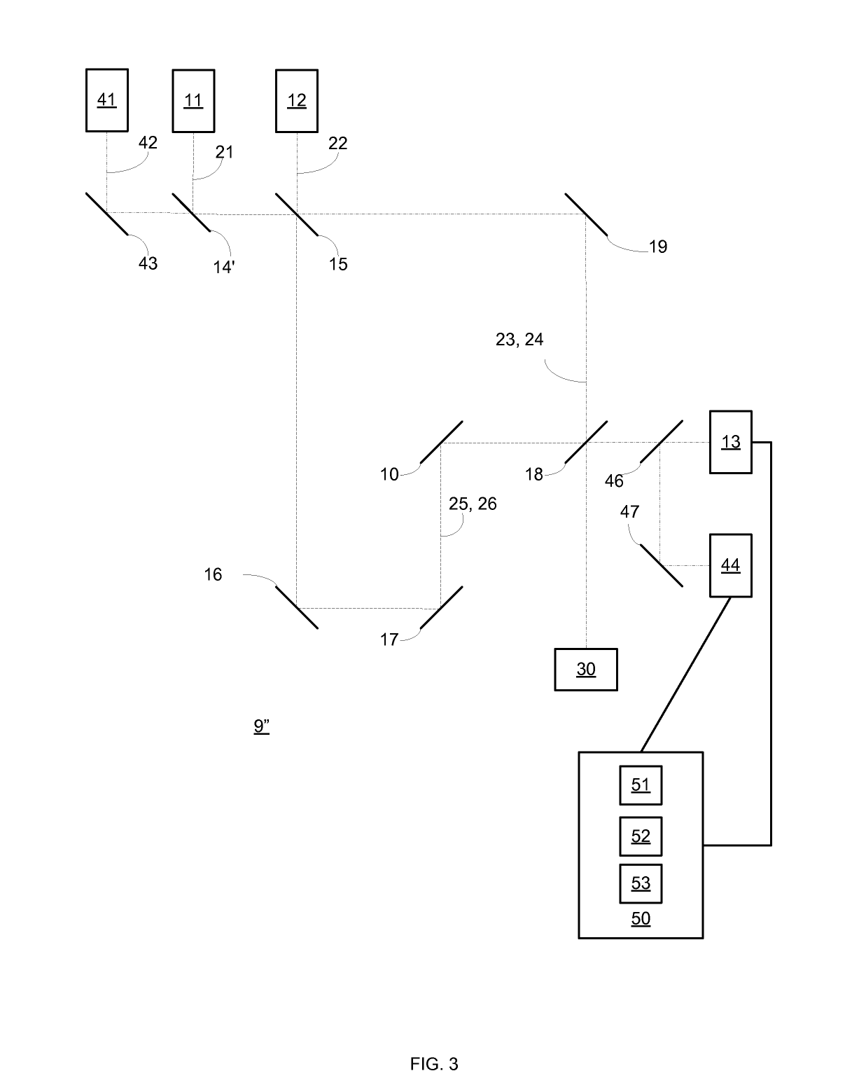

FIG. 3 illustrates a system 9″ according to an embodiment of the invention. System 9″ of FIG. 3 differs from system 9′ of FIG. 2 by including an additional sensor 44, an additional mirror 47 and an additional beam splitter 47. The additional sensor 44 may sense the additional interference patterns or the first interference patterns or the second interference pattern but this is not necessarily so. The additional mirror 47 and the additional beam splitter 47 direct interference patterns to sensor 44 and to sensor 13.

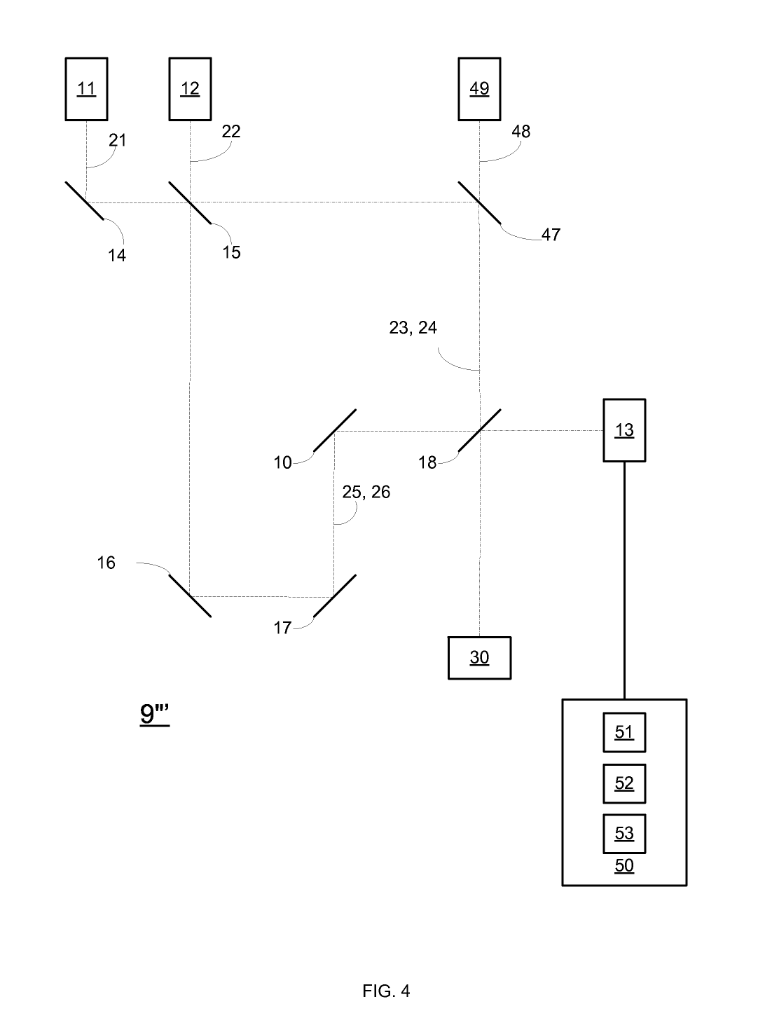

FIG. 4 illustrates a system 9′″ according to an embodiment of the invention. System 9′″ of FIG. 4 differs from system 9 of FIG. 1 by including an additional light source 49 and by replacing mirror 19 by beam splitter 47.

The beam splitter 47 acts as a mirror in relation to first and second light beams 23 and 24 but also allows an additional light beam from additional light source 49 to pass through it an impinge on sample 30. This additional light beam is not associated with a reference light beam and is of a wavelength that differs from w1 and w2 and thus does not generate interference patterns. It is used to generate a two-dimensional image of the area.

It is noted that the two-dimensional image can be generated by a dedicated sensor or can be generated by blocking (or otherwise not generating) the first or second reference light beams.

Processor 50 is arranged to receive or generate a two dimensional image of the area and to detect, in the first and second wavelength phase information, the first and second wavelength extremum portion information based on a location of the extremum portion in the two dimensional image.

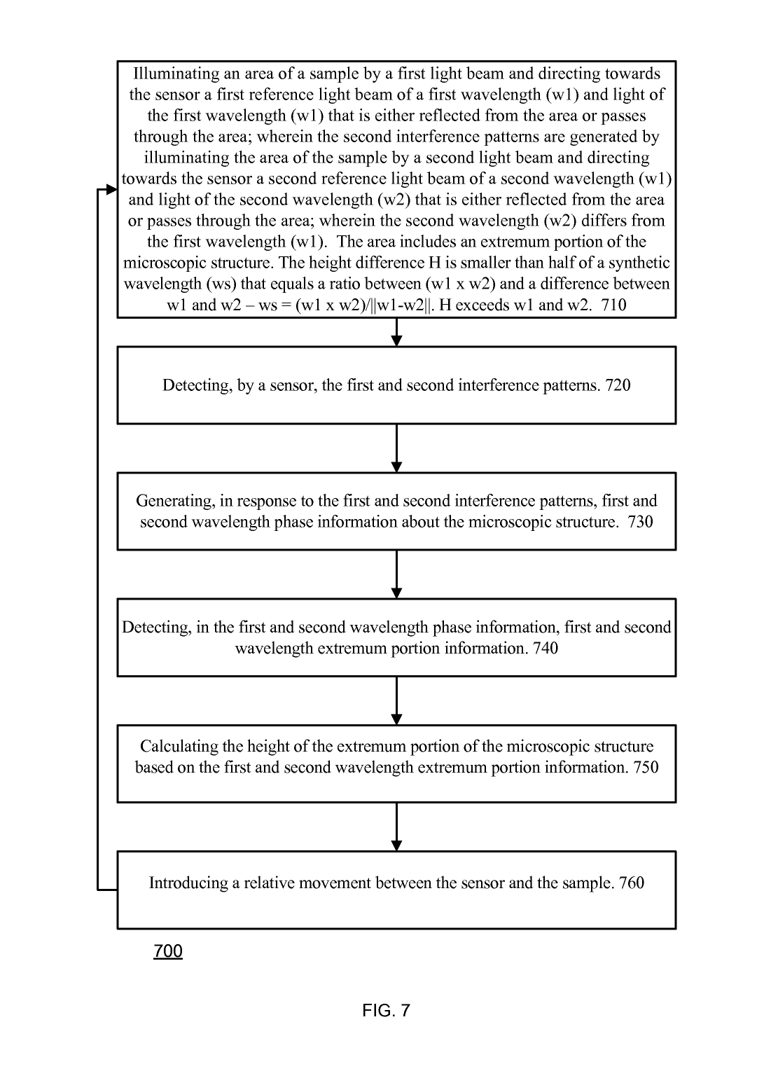

FIG. 7 illustrates a method 700 according to an embodiment of the invention.

Method 700 can be utilized for measuring a height difference (H) between an extremum portion of a microscopic structure and a background element.

Method 700 may start by stage 710 of illuminating an area of a sample by a first light beam and directing towards the sensor a first reference light beam of a first wavelength (w1) and light of the first wavelength (w1) that is either reflected from the area or passes through the area; wherein the second interference patterns are generated by illuminating the area of the sample by a second light beam and directing towards the sensor a second reference light beam of a second wavelength (w2) and light of the second wavelength (w2) that is either reflected from the area or passes through the area; wherein the second wavelength (w2) differs from the first wavelength (w1).

Second wavelength w2 differs from first wavelength w1 . The area includes an extremum portion of the microscopic structure. The height difference H is smaller than half of a synthetic wavelength (ws) that equals a ratio between (w1×w2) and a difference between w1 and w2−ws=(w1×w2)/∥w1−w2∥. H exceeds w1 and w2. The synthetic wavelength can be the wavelength of the beating resulting from the combination of the first and second interference patterns.

Each reference light beam can be generated by the same light source as the light beam (of the same wavelength) but may propagate through a different path of different optical length.

Stage 710 may include illuminating the area by the first light beam at a first angle of incidence and illuminating the area by the second light beam at a second angle of incidence that differs from the first angle of incidence. This angular difference may assist in separating between the first and second interference patterns.

Stage 710 is followed by stage 720 of detecting, by a sensor, the first and second interference patterns.

Stage 720 is followed by stage 730 of generating, in response to the first and second interference patterns, first and second wavelength phase information about the microscopic structure. Stage 720 may include applying known digital holographic microscopy algorithms.

Stage 730 is followed by stage 740 of detecting, in the first and second wavelength phase information, first and second wavelength extremum portion information.

Stage 740 may include at least one of the following: (i) detecting, in the first and second wavelength phase information, the first and second wavelength extremum portion information based on an expected location of the extremum portion wherein the expected location can be learnt from locations of other structural elements, can be driven from design information or any other manner; (ii) detecting, in the first and second wavelength phase information, the first and second wavelength extremum portion information based on a location of the extremum portion in a two dimensional image that may be acquired by the same sensor (using non-holographic illumination) or using another sensor; (iii) filtering first and second wavelength phase information pixels based on an expected height of the extremum portion; (iv) detecting pixels that represent very low or no reflectance wherein at least a predefined minimal number of such pixels can provide an indication about an intermediate portion of the microscopic structure that is not expected to reflect light towards the sensor, and defining pixels that are proximate to these pixels as belonging to the extremum portion.

Stage 740 is followed by stage 750 of calculating the height of the extremum portion of the microscopic structure based on the first and second wavelength extremum portion information.

Stage 750 may include at least one of the following: (i) calculating the height of the extremum portion of the microscopic structure by averaging pixels of the first and second wavelength extremum portion information, the averaging can reduce errors; (ii) calculating the height of the extremum portion of the microscopic structure by applying a spatial filter on pixels of the first and second wavelength extremum portion information; (iii) calculating the height of the extremum portion of the microscopic structure based on a large number of pixels (for example—at least fifty pixels) of the first and second wavelength extremum portion information. Larger numbers of processed pixels can increase the accuracy of the measurement.

The mentioned above stages (stages 710-750) can be repeated for other areas of the sample and for other microscopic structures. This is illustrated by stage 760 of introducing a relative movement between the sensor and the sample and jumping to stage 710 in order to measure the height of yet another structural element or another area. The repetition can proceed until completing a scan pattern or until another criterion is fulfilled.

Method 700 was illustrated as being applied to light beams of two wavelengths. It is noted that the method can be applied mutatis mutandis to more than two wavelengths. Especially it can be applied to any number of wavelengths that exceeds K, wherein K can be bigger than 2, 3, 4, 5, 6, 7, 8 or any other positive integer.

The number of sensors that are required to detect the different light beams of N wavelengths can be M, wherein M can equal K, can be smaller than K or exceed K.

When using light beams of N wavelengths, these light beams can illuminate the area simultaneously, in an overlapping manner, in a non-overlapping manner or in a combination thereof. It is noted that multiple structural elements can be illuminated and measured in parallel.

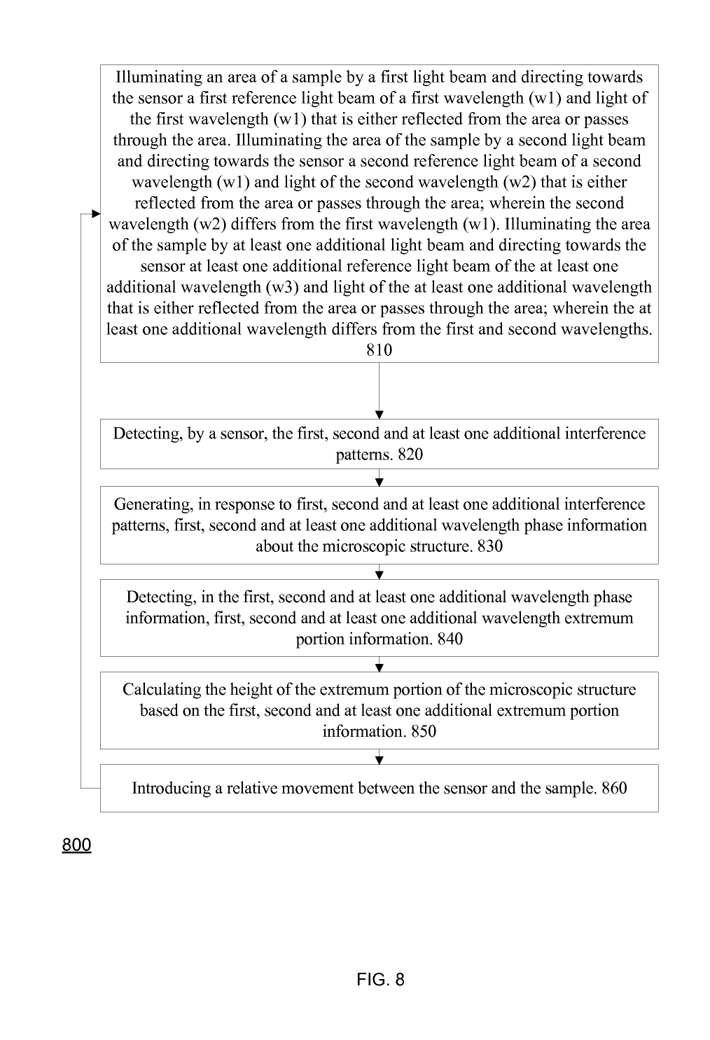

The utilization of more than light beams of more than two wavelengths is illustrated by FIG. 8.

FIG. 8 illustrates a method 800 according to an embodiment of the invention.

Method 800 can be utilized for measuring a height difference (H) between an extremum portion of a microscopic structure and a background element.

Method 800 may start by stage 810 of: (a) illuminating an area of a sample by a first light beam and directing towards the sensor a first reference light beam of a first wavelength (w1) and light of the first wavelength (w1) that is either reflected from the area or passes through the area; (b) illuminating the area of the sample by a second light beam and directing towards the sensor a second reference light beam of a second wavelength (w2) and light of the second wavelength (w2) that is either reflected from the area or passes through the area; wherein the second wavelength (w2) differs from the first wavelength (w1); and (c) illuminating the area of the sample by at least one additional light beam and directing towards the sensor at least one additional reference light beam of the at least one additional wavelength (wi) and light of the at least one additional wavelength that is either reflected from the area or passes through the area; wherein the at least one additional wavelength differs from the first and second wavelengths. There can be multiple additional wavelengths that differ from each other. Usually at least one synthetic wavelength will have a beating interference half wavelength that is larger compare to the height of the highest steep structure (“step”) in the field of view. The angle of incidence of each additional light beam may differ from the angle of incidence of all other light beams.

Stage 810 is followed by stage 820 of detecting, by a sensor, the first, second and at least one additional interference patterns.

Stage 820 is followed by stage 830 of generating, in response to first, second and at least one additional interference patterns, first, second and at least one additional wavelength phase information about the microscopic structure.

Stage 830 is followed by stage 840 of detecting, in the first, second and at least one additional wavelength phase information, first, second and at least one additional wavelength extremum portion information.

Stage 840 is followed by stage 850 of calculating the height of the extremum portion of the microscopic structure based on the first, second and at least one additional extremum portion information.

The mentioned above stages (stages 810-850) can be repeated for other areas of the sample and for other microscopic structures. This is illustrated by stage 860 of introducing a relative movement between the sensor and the sample and jumping to stage 810 in order to measure the height of yet another structural element or another area. The repetition can proceed until completing a scan pattern or until another criterion is fulfilled.

Any of the mentioned above methods or a combination thereof (of methods or method stages) can be executed by a computer that executed instructions stored in a non-transitory computer readable medium of a computer program product.

It is noted that the order of stage of each method (even if referred to as a sequence of stages) can differ from the order illustrated in the figure and that stages can be executed out of order, in an overlapping or at least partially overlapping manner.

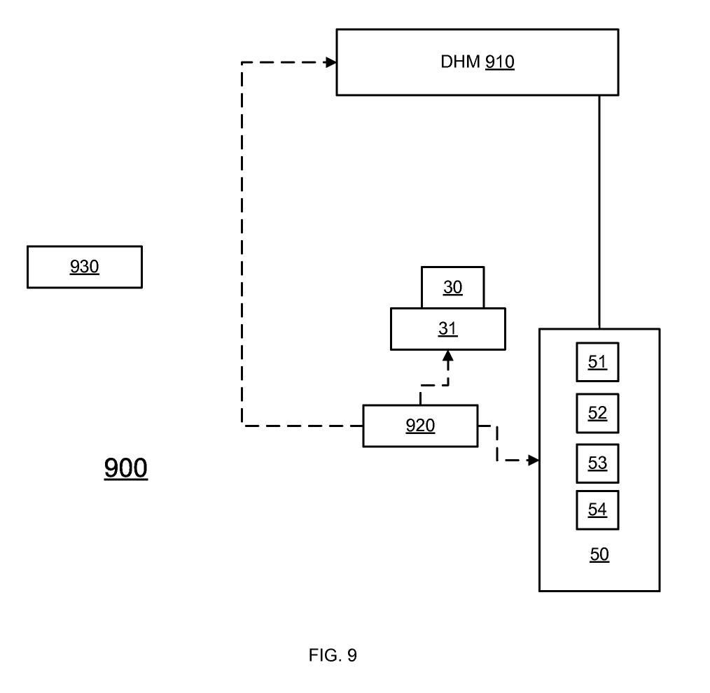

FIG. 9 illustrates a system 900 according to an embodiment of the invention.

System 900 may include: (i) Digital holography optics that may include at least one set of two or more lasers (that creates “synthetic wavelength”) for generating the hologram on the digital sensor (camera); (ii) lenses and beam splitters; (iii) a sensor such as a camera for recording holographic images and output a digital representation or analog representation that later will be transformed to digital format; (iv) digital holography software that may be executed by a processor to process a hologram image, creating a phase and amplitude image and de-coding it into 2D height map; (v) a processing computer—to execute digital holography processing and subsequent algorithms; (vi) load/unload modules (manual or automatic) for manipulating the inspected object; and (vii) motion modules such as a stage for moving the inspected object in relation to the optics. These elements are illustrated below. Elements (i)-(v) may be part of the digital holographic microscope (DHM) 910, element (vi) can be a load/unload unit 930, and element (vii) can be stage 31.

System 900 is an Automatic Optical Inspection (AOI) system. It may include either one of system 9 of FIG. 1, system 9′ of FIG. 2, system 9″ of FIG. 3 and system 9′″ of FIG. 4.

System 900 may include a digital holographic microscope (DHM) 910. Referring to FIG. 1, the DHM may include sensor 13, first light source 11 and second light source 12, optical elements such as mirrors 14, 16, 17, 19 and 10, beam splitters 15 and 18 and lenses and generating module 51.

System 900 may also include stage 31 for introducing a movement between the sample and the sensor. It may include more than a single stage and may include a stage for moving the sensor.

DHM 910 may illuminate an inspected object (sample), one area after the other, by multiple illumination sources to generate interference patterns and analyze these interference patterns to obtain 3D and even 2D information of the illuminated areas. An area can be simultaneously illuminated by a light beam and a reference beam to generate interference patterns that may provide a holographic image of the area.

The holographic image can be processed by processor 50 (that may be a distributed or a centralized computing unit) that may be arranged to apply one or more algorithms for reconstructing three-dimensional (3D) information, two dimensional (2D) information or both. FIG. 9 illustrates processor 50 as including a 2D image processing module 54. Such a module can also be included in any of the mentioned above systems.

System 900 system can also include a controller 920 for determining when to extract 3D information, and/or 2D information based on various parameters such as an estimated location of 3D patterns of interest (such as bumps), time constraints (2D information can be easier to extract), and the like.

System 900 can include additional optics for illuminating other portions of the inspected object. These optical may include a 2D camera or any other optical path arranged to obtain information.

The inclusion of DHM 910 within system 900 allows scanning 3D structures in high speed with repeatability required for next generation bumps (below 10 micron).

Real time and even off line processing allows getting high resolution 2D image while measuring 3D structures (2D and 3D at the same time).

When inspecting an object 30 the controller 920 can determine which measurement mode to apply (2D, 3D, combined etc.).

System 900 may also include a loading and unloading unit such as load/unload unit 930 although such unit may not be a part of system 900.

System 900 may acquire images from one or more relevant areas during motion of the sample 30. This may involve short exposure time, as the system 900 does not need to stop the scanning process for acquiring the images. Thus, pulsating illumination or pulsating sensors can be used.

Holographic images may be sent to processor 50 (such as a distributed computer) for processing.

The holographic image may be processed by the processor 50 using digital holography algorithm creating both phase and amplitude image, including bumps 2D height map H=f(X,Y).

2D bumps height map may be processed by 3D algorithms for each bump height calculation with respect to pre-defined surface area

Post processing algorithms may be applied for die-level statistics calculation (such as co-planarity etc.).

Results may then be reported (into file, screen etc.)

System 900 may perform at least one of the following:

i. 3D measurement/metrology.
ii. 2D (amplitude) image acquisition.
iii. Extraction of 2D and 3D information from the same image —height measurement and defect detection;
iv. Verification of defects—using 3D information and/or 2D information.
v. Classification of defects—using 3D information and/or 2D information for manual/automatic classification.

The DHM 910 may acquire 2D holographic images (e.g. 1 M pixels) in about 10 microseconds and get the 3D information from it. The 3D data may be calculated from a single 2D frame, single image can give the complete 3D data, eliminating a need for vertical scan of any kind.

The repeatability of measurement may be set to a threshold such as a threshold that is much smaller than 1% of measurement range.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for measuring a height difference (H) between a extremum portion of a microscopic structure and a background element, the method comprises:
detecting, by a sensor, first and second interference patterns by a sensor; wherein the first interference patterns are generated by illuminating an area of a sample by a first light beam and directing towards the sensor a first reference light beam of a first wavelength (w1) and light of the first wavelength (w1) that is either reflected from the area or passes through the area; wherein the second interference patterns are generated by illuminating the area of the sample by a second light beam and directing towards the sensor a second reference light beam of a second wavelength (w2) and light of the second wavelength (w2) that is either reflected from the area or passes through the area; wherein the second wavelength (w2) differs from the first wavelength (w1); wherein the area comprises the extremum portion of the microscopic structure; wherein the height different H is smaller than half of a synthetic wavelength (ws) that equals a ratio between (w1×w2) and a difference between w1 and w2; wherein H exceeds w1 and w2;
generating, in response to the first and second interference patterns, first and second wavelength phase information about the microscopic structure;
detecting, in the first and second wavelength phase information, first and second wavelength extremum portion information; and
calculating the height of the extremum portion of the microscopic structure based on the first and second wavelength extremum portion information.

2. The method according to claim 1 wherein the first light beam impinges on the area at a first angle of incidence; wherein the second light beam impinges on the area at a second angle of incidence that differs from the first angle of incidence.

3. The method according to claim 1, wherein the first wavelength (w1) light and the second wavelength (w2) light are generated in an optical frequency comb or are part of an optical frequency comb.

4. The method according to claim 1, comprising detecting, in the first and second wavelength phase information, the first and second wavelength extremum portion information based on an expected location of the extremum portion.

5. The method according to claim 1, comprising obtaining a two dimensional image of the area and detecting, in the first and second wavelength phase information, the first and second wavelength extremum portion information based on a location of the extremum portion in the two dimensional image.

6. The method according to claim 1, comprising filtering first and second wavelength phase information pixels based on an expected height of the extremum portion.

7. The method according to claim 1, comprising calculating the height of the extremum portion of the microscopic structure by averaging pixels of the first and second wavelength extremum portion information.

8. The method according to claim 1, comprising calculating the height of the extremum portion of the microscopic structure by applying a spatial filter on pixels of the first and second wavelength extremum portion information.

9. The method according to claim 1, comprising calculating the height of the extremum portion of the microscopic structure based on at least fifty pixels of the first and second wavelength extremum portion information.

10. The method according to claim 1, wherein the microscopic structure further comprises an intermediate portion positioned between the extremum portion and the background element; wherein light reflected from the intermediate portion, as a result from the illumination of the area by the first and second light beams, is outside a field of view of the sensor. The method according to claim 10, wherein the first and second wavelength phase information about the microscopic structure comprise first and second wavelength intermediate information that comprises pixels of values representative of an insignificant reflectance of light from the intermediate portion.

11. The method according to claim 1, comprising detecting pixels of the first and second wavelength intermediate information based on values of pixels representative of an insignificant reflectance of light from the intermediate portion; and detecting a location of pixels of the first and second wavelength extremum information based on locations of the pixels of the first and second wavelength intermediate information.

12. The method according to claim 1, wherein the structural element is a microscopic bump.

13. The method according to claim 1, wherein the structural element is a conductor having a microscopic height.

14. The method according to claim 1, comprising introducing a relative movement between the sensor and the sample and detecting first and second interference patterns from multiple areas that differ from each other; and repeating the generating, detecting and calculating from multiple microscopic structures located in the different areas.

15. The method according to claim 1, comprising:
detecting, by the sensor, at least one additional interference patterns; wherein the at least one additional interference patterns are generated by illuminating the area of the sample by at least one additional light beam and directing towards the sensor at least one additional wavelength reference light beam of at least one additional wavelength and light of the at least one additional wavelength that is either reflected from the area or passes through the area; wherein the at least one additional wavelength differs from the first and second wavelengths;
generating, in response to first, second and at least one additional interference patterns, first, second and at least one additional wavelength phase information about the microscopic structure;
detecting, in the first, second and at least one additional wavelength phase information, first, second and at least one additional wavelength extremum portion information; and
calculating the height of the extremum portion of the microscopic structure based on the first, second and at least one additional extremum portion information.

16. The method according to claim 15, wherein the first wavelength (w1) light and the second wavelength (w2) light and the additional wavelengths light are generated in an optical frequency comb or are part of an optical frequency comb.

17. The method according to claim 1, comprising:
detecting, by at least one additional sensor, at least one additional interference patterns; wherein the at least one additional interference patterns are generated by illuminating the area of the sample by at least one additional light beam and directing towards the sensor at least one additional wavelength reference light beam of at least one additional wavelength and light of the at least one additional wavelength that is either reflected from the area or passes through the area; wherein the at least one additional wavelength differs from the first and second wavelengths;
generating, in response to first, second and at least one additional interference patterns, first, second and at least one additional wavelength phase information about the microscopic structure;
detecting, in the first, second and at least one additional wavelength phase information, first, second and at least one additional wavelength extremum portion information; and
calculating the height of the extremum portion of the microscopic structure based on the first, second and at least one additional extremum portion information.

18. The method according to claim 1, comprising:
detecting, by a group of sensors that comprises the sensor and at least zero additional sensors, multiple additional interference patterns; wherein the at least one additional interference patterns are generated by illuminating the area of the sample by multiple additional light beams and directing towards the sensor multiple additional wavelengths reference light beam of multiple additional wavelengths and light of the multiple additional wavelengths that is either reflected from the area or passes through the area; wherein the multiple additional wavelengths differs from the first and second wavelengths;
generating, in response to first, second and multiple additional interference patterns, first, second and multiple additional wavelength phase information about the microscopic structure;
detecting, in the first, second and multiple additional wavelength phase information, first, second and multiple additional wavelength extremum portion information; and
calculating the height of the extremum portion of the microscopic structure based on the first, second and multiple additional extremum portion information.

19. A system for measuring a height difference (H) between a extremum portion of a microscopic structure and a background element, the system comprises:
a sensor arranged to detect, first and second interference patterns by a sensor; wherein the first interference patterns are generated by wherein the first interference patterns are generated by illuminating an area of a sample by a first light beam and directing towards the sensor a first reference light beam of a first wavelength (w1) and light of the first wavelength (w1) that is either reflected from the area or passes through the area; wherein the second interference patterns are generated by illuminating the area of the sample by a second light beam and directing towards the sensor a second reference light beam of a second wavelength (w2) and light of the second wavelength (w2) that is either reflected from the area or passes through the area; wherein the second wavelength (w2) differs from the first wavelength (w1); wherein the area comprises the extremum portion of the microscopic structure; wherein the height different H is smaller than half of a synthetic wavelength (ws) that equals a ratio between (w1×w2) and a difference between w1 and w2; wherein H exceeds w1 and w2;
and a processor, arranged to:
generate, in response to the first and second interference patterns, first and second wavelength phase information about the microscopic structure;
detect, in the first and second wavelength phase information, first and second wavelength extremum portion information; and
calculate the height of the extremum portion of the microscopic structure based on the first and second wavelength extremum portion information.

20. The system according to claim 19, wherein the first light beam impinge on the area at a first angle of incidence; wherein the second light beam impinge on the area at a second angle of incidence that differs from the first angle of incidence.

21. The system according to claim 19, wherein the first wavelength (w1) light and the second wavelength (w2) light are generated in an optical frequency comb or are part of an optical frequency comb.

22. The system according to claim 19, wherein the processor is arranged to detect, in the first and second wavelength phase information, the first and second wavelength extremum portion information based on an expected location of the extremum portion.

23. The system according to claim 19, wherein the processor is arranged to receive a two dimensional image of the area and to detect, in the first and second wavelength phase information, the first and second wavelength extremum portion information based on a location of the extremum portion in the two dimensional image.

24. The system according to claim 19, wherein the processor is arranged to filter first and second wavelength phase information pixels based on an expected height of the extremum portion.

25. The system according to claim 19, wherein the processor is arranged to calculating the height of the extremum portion of the microscopic structure by averaging pixels of the first and second wavelength extremum portion information.

26. The system according to claim 19, wherein the processor is arranged to calculate the height of the extremum portion of the microscopic structure by applying a spatial filter on pixels of the first and second wavelength extremum portion information.

27. The system according to claim 19, wherein the processor is arranged to calculating the height of the extremum portion of the microscopic structure based on at least fifty pixels of the first and second wavelength extremum portion information.

28. The system according to claim 19, wherein the microscopic structure further comprises an intermediate portion positioned between the extremum portion and the background element; wherein light reflected from the intermediate portion, as a result from the illumination of the area by the first and second light beams, is outside a field of view of the sensor.

29. The method according to claim 28, wherein the first and second wavelength phase information about the microscopic structure comprise first and second wavelength intermediate information that comprises pixels of values representative of an insignificant reflectance of light from the intermediate portion.

30. The system according to claim 19, wherein the processor is arranged to detect pixels of the first and second wavelength intermediate information based on values of pixels representative of an insignificant reflectance of light from the intermediate portion; and to detect a location of pixels of the first and second wavelength extremum information based on locations of the pixels of the first and second wavelength intermediate information.

31. The system according to claim 19, wherein the structural element is a microscopic bump.

32. The system according to claim 19, wherein the structural element is a conductor having a microscopic height.

33. The system according to claim 19, comprising a stage arranged to introduce a relative movement between the sensor and the sample; wherein the sensor is arranged to detect first and second interference patterns from multiple areas that differ from each other; wherein the processor is arranged to repeat to generate first and second wavelength phase information about the microscopic structure; to detect first and second wavelength extremum portion information; and to calculate the height of extremum portions of microscopic structures located in the different areas.

34. The system according to claim 19, wherein the sensor is arranged to detect at least one additional interference patterns;
wherein the at least one additional interference patterns are generated by illuminating the area of the sample by at least one additional light beam and combine the reflected or transmitted light with at least one additional reference light beam of at least one additional wavelength that differs from the first and second wavelengths;
wherein the processor is arranged to:
generate, in response to first, second and at least one additional interference patterns, first, second and at least one additional wavelength phase information about the microscopic structure;
detect, in the first, second and at least one additional wavelength phase information, first, second and at least one additional wavelength extremum portion information; and
calculate the height of the extremum portion of the microscopic structure based on the first, second and at least one additional extremum portion information.

35. The system according to claim 34, wherein the first wavelength (w1) light and the second wavelength (w2) light and the additional wavelengths light are generated in an optical frequency comb or are part of an optical frequency comb.

36. The system according to claim 19, comprising:
at least one additional sensor, arranged to detect at least one additional interference patterns; wherein the at least one additional interference patterns are generated by illuminating the area of the sample by at least one additional light beam and combine the reflected or transmitted light with at least one additional reference light beam of at least one additional wavelength that differs from the first and second wavelengths;
wherein the processor is arranged to:
generate, in response to first, second and at least one additional interference patterns, first, second and at least one additional wavelength phase information about the microscopic structure;
detect, in the first, second and at least one additional wavelength phase information, first, second and at least one additional wavelength extremum portion information; and
calculate the height of the extremum portion of the microscopic structure based on the first, second and at least one additional extremum portion information.

37. The system according to claim 19, comprising a group of sensors that comprises the sensor and at least zero additional sensors, the group of sensors arranged to detect multiple additional interference patterns; wherein the at least one additional interference patterns are generated by illuminating the area of the sample by multiple additional light beams and combine the reflected or transmitted light with multiple additional reference light beams of multiple additional wavelengths that differs from the first and second wavelengths;
wherein the processor is arranged to:
generate, in response to first, second and multiple additional interference patterns, first, second and multiple additional wavelength phase information about the microscopic structure;
detect, in the first, second and multiple additional wavelength phase information, first, second and multiple additional wavelength extremum portion information; and calculate the height of the extremum portion of the microscopic structure based on the first, second and multiple additional extremum portion information.

38. A computer program product that comprises a non-transitory computer readable medium that stores instructions for measuring a height difference (H) between a extremum portion of a microscopic structure and a background element, the instruction comprise instructions for:
detecting, by a sensor, first and second interference patterns by a sensor; wherein the first interference patterns are generated by illuminating an area of a sample by a first light beam and directing towards the sensor a first reference light beam of a first wavelength (w1) and light of the first wavelength (w1) that is either reflected from the area or passes through the area; wherein the second interference patterns are generated by illuminating the area of the sample by a second light beam and directing towards the sensor a second reference light beam of a second wavelength (w2) and light of the second wavelength (w2) that is either reflected from the area or passes through the area; wherein the second wavelength (w2) differs from the first wavelength (w1); wherein the area comprises the extremum portion of the microscopic structure; wherein the height different H is smaller than half of a synthetic wavelength (ws) that equals a ratio between (w1×w2) and a difference between w1 and w2; wherein H exceeds w1 and w2;
generating, in response to the first and second interference patterns, first and second wavelength phase information about the microscopic structure;
detecting, in the first and second wavelength phase information, first and second wavelength extremum portion information; and
calculating the height of the extremum portion of the microscopic structure based on the first and second wavelength extremum portion information.
